(19) United States
(12) Patent Application Publication
(10) Pub. No.: US 2025/0287855 A1
(43) Pub. Date: Sep. 18, 2025

(54) Method for Controlling the Lift Position on a Tractor-Mounted Agricultural Machine, Control System and Tractor-Mounted Machine

(71) Applicant: Amazonen-Werke H. Dreyer Se & Co. Kg, Hasbergen (DE)

(72) Inventors: Tino LENZ, Leipzig (DE); Daniel MERTENS, Oldenburg (DE)

(73) Assignee: Amazonen-Werke H. Dreyer Se & Co. Kg, Hasbergen (DE)

(21) Appl. No.: 18/860,729

(22) PCT Filed: Apr. 24, 2023
(86) PCT No.: PCT/EP2023/060568

§ 371 Date: Oct. 28, 2024

(30) Foreign Application Priority Data
May 2, 2022 (DE) 10 2022 110 628.4

(51) Int. Cl. A01B 63/00

(52) U.S. Cl. CPC A01B 63/008

(57) ABSTRACT

The invention relates to a method for controlling the lifting position of an agricultural attachment machine, such as a seeder or soil cultivation machine, during a cultivation operation on agricultural arable land.

### CROSS REFERENCE TO RELATED APPLICATIONS

The present application claims priority under 35 U.S.C. § 365 to PCT/EP2023/060568 filed on Apr. 24, 2023 and under 35 U.S.C. § 119(a) to German Application No. 10 2022 110 628.4 filed on May 2, 2022, which are hereby incorporated by reference in their entireties.

### TECHNICAL FIELD

The disclosure relates to a method for controlling the lifting position at an agricultural attachment machine, in particular at a seeder or at a soil cultivation machine, during a cultivation operation on agricultural arable land.

The disclosure additionally relates to a control system for controlling the lifting position at an agricultural attachment machine, in particular at a seeder or at a soil cultivation machine, during a cultivation operation on agricultural arable land.

The disclosure furthermore relates to an agricultural attachment machine, in particular to a seeder or to a soil cultivating machine, with at least one soil cultivating and/or material depositing device and a control system for controlling the lifting position of the at least one soil cultivating and/or material depositing device.

### BACKGROUND

Agricultural attachment machines, in particular seeders or soil cultivation machines, carry out maneuvering operations when cultivating agricultural arable land with soil cultivating and/or material depositing devices, for example, when turning around, when the machine has reached the edge of arable land or when the machine is travelling on the headland. In order to avoid damage to the tools that can be caused by collisions with the ground, the soil cultivating and material depositing devices of the attachment machine, for example, the seed colters of a seeder or the tine colters of a hoe, are lifted up from their working position during maneuvering operations so that they are no longer in contact with the ground during the maneuvering operations.

In order to lift soil cultivating and/or material depositing devices of an agricultural attachment machine, prior machines specify a position at a distance from the ground to which the soil cultivating and/or material depositing devices are moved. Publication DE 10 2019 108 987 A1, for example, shows an adjustment device that can move soil cultivating tools arranged on the side members of an agricultural work machine from a fixedly defined working position to a fixedly defined headland position in order to lift the cultivation tools, for example, at the headland. To do this, the side members of the work machine are pivoted to a fixedly defined angular position relative to a central member.

Also, a switching device is also known from publication DE 10 2010 025 944 A1 by way of which a working device of an agricultural distribution machine can be adjusted to a working position for distributing seed and to a headland position for turning the distribution machine around.

In this respect, it is already known to lift soil cultivating and/or material depositing devices of an agricultural attachment machine when turning the attachment machine around. Hitherto, however, the soil cultivating and/or material depositing devices have only been lifted to a fixedly defined position. In order to prevent the soil cultivating and/or material depositing devices from colliding with the ground during all conceivable turning maneuvers, a correspondingly very high predefined lifting position must always be set in order to always reliably avoid damage to the soil cultivating and/or material depositing devices from unintentional contact with the ground. However, with such a high lifting position, long lifting times arise when raising and lowering the soil cultivating and/or material depositing devices, meaning that the attachment machine is exposed to long idle times during field work. Field work is therefore significantly delayed by setting the high lifting position.

### SUMMARY

The object underlying the disclosure is therefore to optimize the lifting of soil cultivating and/or material depositing devices at an agricultural attachment machine in such a way that delays in field work due to long idle times of the attachment machine are minimized without increasing the risk of damage to the soil cultivating and/or material depositing devices from unintentional contact with the ground during turning maneuvers.

The object is satisfied by a method of the kind mentioned at the outset, wherein at least one soil cultivating and/or material depositing device of the agricultural attachment machine is temporarily lifted from a working position to a first predefined lifting position of at least two predefined lifting positions in at least one first category of maneuvering processes and wherein the at least one soil cultivating and/or material depositing device of the agricultural attachment machine is temporarily lifted from the working position to a second predefined lifting position of the at least two predefined lifting positions in at least one second category of maneuvering processes.

At least two predefined lifting positions, which can be set in at least two categories of maneuvering operations of the agricultural attachment machine, have the advantage over a single predefined lifting position that, when raising at least one soil cultivating and/or material depositing device, it is no longer necessary to solely set a very high lifting position, but at least one further lifting position, for example, a lifting position that is less high can also be set when taking into account the maneuvering operation in the event that the maneuvering operation does not require a very high lifting position in order to protect the soil cultivating and/or material depositing devices from ground collisions. The at least two predefined lifting positions therefore always allow for the optimal lifting position to be set during field cultivation that is suitable for a maneuvering operation so that the soil cultivating and/or material depositing devices can be protected from damage without unnecessary delays in field cultivation.

During the cultivation process on agricultural arable land, a control device can optionally cause at least one soil cultivating and/or material depositing device of the agricultural attachment machine to be raised from the working position to the first predefined lifting position or to the second predefined lifting position of at least two predefined lifting positions.

The at least one soil cultivating and/or material depositing device can be, for example, a coltor, a disc, a harrow, a tire and/or a roller. If there are several soil cultivating and/or material depositing devices, they can be arranged at the agricultural attachment machine adjacent to one another transverse to the direction of travel and/or one behind the other parallel to the direction of travel.

The at least one soil cultivating and/or material depositing device can be arranged at least one segment of at least one carrier. The at least one soil cultivating and/or material depositing device can be raised by lifting the at least one segment of the at least one carrier. The at least one carrier can be part of a rear frame of the attachment machine. The at least one rear frame is preferably arranged at a main frame of the agricultural attachment machine. The at least one rear frame or at least one segment of the at least one rear frame is preferably attached to be rotatable or pivotable on the main frame of the agricultural machine. The at least one carrier can also be configured as a boom. The at least one boom or at least one segment of the at least one boom is preferably attached to be rotatable or pivotable on the main frame and/or the rear frame of the agricultural attachment machine. Several segments of the at least one carrier can preferably be lifted independently of one another and/or have different lifting positions at the same time. A lifting position sensor is preferably arranged at the attachment machine, for example, at the rear frame or at the main frame, and detects the current lifting position and/or a current change in the lifting position. Individual segments can have different lifting positions at the same time. The agricultural attachment machine can be a soil cultivation machine, in particular a hoeing device.

In a preferred embodiment of the method according to the disclosure, at least one maneuvering process is assigned to the first or the second category of maneuvering processes prior to the maneuvering process being performed. Alternatively or additionally, at least one maneuvering process is assigned to the first or the second category of maneuvering processes while the maneuvering process is being performed. The maneuvering processes are preferably assigned to the first or second category of maneuvering processes by a control device.

In a further preferred embodiment of the method according to the disclosure, the assignment of the at least one maneuvering process to the first or the second category of maneuvering processes is carried out as a function of a current direction of travel and/or an impending change in the direction of travel of the agricultural attachment machine. The direction of travel of the attachment machine can be forward, backward or sideways. When the direction of travel changes, the direction of travel can be changed from forward to backward or from backward to forward. When changing the direction of travel, the direction of travel can be changed from forward to sideways or from backward to sideways as well as from sideways to forward or from sideways to backward. When changing the direction of travel, the direction of travel can be changed by cornering and/or a turning maneuver. A change in direction of travel can comprise a temporary standstill of the attachment machine. The assignment to the first or the second category can be effected as a function of whether the current direction of travel of the attachment machine is forward or backward. The assignment to the first or the second category can be effected as a function of whether the attachment machine will change its direction of travel in the near future.

In addition, a method according to the disclosure is advantageous in which the agricultural attachment machine does not reverse during the maneuvering processes of the first category and the agricultural attachment machine does reverse during the maneuvering processes of the second category. During parallel travel and/or connecting travel of the attachment machine, the turning maneuvers typically do not entail any reversing. During connecting travel, the agricultural attachment machine travels in parallel strips, preferably turning forward in a 180-degree turn at the edge of the field. Turning maneuvers with reversing are to be expected, in particular when the attachment machine travels on the headland. Travelling on the headland is understood to mean travel of the attachment machine in the edge area of a field in the vicinity of the field boundaries. In order to completely cultivate all areas of a field, in particular the corner areas, the agricultural attachment machine must reverse into the corner areas of the field area when traveling on the headland.

A method according to the disclosure is also preferred in which no cornering takes place during the maneuvering processes of the first category and/or the agricultural attachment machine performs cornering in which a limit value for the machine tilt is likely not to be exceeded, and in the maneuvering processes of the second category, the agricultural attachment machine performs cornering in which a limit value for the machine tilt is likely to be reached or exceeded. The turning maneuvers between parallel travel and/or connecting travel of the attachment machine can comprise cornering. Particularly with small curve radii and/or high driving speeds during cornering, for example, in 180-degree turns when turning the attachment machine around between connecting travel, the attachment machine is expected to tilt as a result of the forces acting upon the attachment machine during cornering. Due to the machine tilt of the attachment machine, the soil cultivating and/or material depositing devices, in particular soil cultivating and/or material depositing devices arranged outside of the attachment machine, can inadvertently touch the ground. The tilt of the attachment machine can be detected by sensors, in particular by way of a tilt sensor and/or by way of a gyroscope. A limit value for the machine tilt is preferably set as a function of the machine configuration, in particular of the boom width of an attachment machine.

In a further development of the method according to the disclosure, the current direction of travel and/or an impending change in the direction of travel of the agricultural attachment machine is determined, where the current direction of travel and/or an impending change in the direction of travel of the agricultural attachment machine is determined in particular based on the current machine configuration or an impending change in the machine configuration of the attachment machine and/or based on the current operating status or an impending change in the operating status of the attachment machine. A control device determines the current direction of travel and/or an impending change in the direction of travel of the agricultural attachment machine. A current machine configuration can be the current gear selection of the attachment machine. If a forward gear is currently engaged for the attachment machine, the current direction of travel of the attachment machine is forward; if a reverse gear is currently engaged for the attachment machine, the current direction of travel is backward. A current machine configuration can be a current steering angle of the steering wheel and/or of the wheels of the attachment machine. An impending change in the machine configuration of the attachment machine can be an impending change in the gear selection of the attachment machine. An impending change in the machine configuration can be, for example, an impending change from a forward gear to a reverse gear or a change from a reverse gear to a forward gear of the attachment machine. An impending change in the machine configuration of the attachment machine can be an impending change in the steering angle of the attachment machine. A current operating status of the attachment machine can be current forward travel or current reverse travel, current cornering or a current standstill of the attachment machine. An impending change in the operating status of the attachment machine can be the change from forward travel to reverse travel or the change from reverse travel to forward travel or the change from forward travel or reverse travel to a standstill or from a standstill to forward travel or reverse travel or a change from travelling straight ahead to cornering or the change from cornering to travelling straight ahead by the attachment machine.

In a further preferred embodiment of the method according to the disclosure, the current direction of travel and/or an impending change in the direction of travel of the agricultural attachment machine is determined based on the current speed of motion and/or an impending change in the speed of motion of the attachment machine, and/or the current geographical position of the attachment machine and/or an impending path of motion of the attachment machine. The current speed of motion or a change in the speed of motion of the attachment machine can indicate the current direction of travel or a change in the direction of travel of the attachment machine. Comparatively slow speeds of motion can indicate reversing and/or cornering. Comparatively fast speeds of motion can indicate forward travel. A reduction in the speed of motion can indicate an impending change in the direction of travel, for example, a change from forward travel to reversing and/or cornering. The current speed of motion and the change in the speed of motion can be detected by sensors. For detection of the speed of motion and the change in the speed of motion by sensors, for example, at least one speed sensor, at least one GPS sensor, and/or at least one rotational speed sensor can be used. In addition, a change in the speed of motion can be detected using an acceleration sensor which can detect the deceleration and acceleration of the attachment machine. The current geographical position of the attachment machine and/or an impending path of motion of the attachment machine can indicate a current direction of travel of the attachment machine or an impending change in the direction of travel of the attachment machine. If the attachment machine is in the vicinity of a field boundary of the agricultural arable land and/or the attachment machine is moving towards a field boundary, this can indicate that a change in direction of travel is imminent. If the attachment machine is at a comparatively large distance from the field boundaries, for example, in the middle of agricultural arable land, this indicates that the attachment machine is travelling forward. In addition, the path of motion of the attachment machine, which was predefined, for example, prior to the field cultivation, can indicate a change in direction of travel. Alternatively or additionally, the progress of work during field cultivation can indicate that a change in the direction of travel of the attachment machine is imminent. To determine the path of motion of the attachment machine and/or the progress of work during field cultivation, the agricultural arable land can be divided into partial areas, for example, into a tramline system that the attachment machine follows during field cultivation. The tramline system can be used to pre-plan the course of field cultivation and therefore the change in direction of travel of the attachment machine.

In addition, a method according to the disclosure is advantageous in which the at least one soil cultivating and/or material depositing device is at a first lifting height at the first lifting position and at a second lifting height at the second lifting position, where the second lifting height is higher than the first lifting height. Delays during cultivation can be reduced by having at least two lifting positions of different heights, since a high lifting position is not required for turning maneuvers without reversing and/or when cornering with a slight machine tilt. This means that the machine does not have to remain stationary for more or less time while the lifting position is being adjusted. The automatic selection of the appropriate lifting position makes field cultivation more time and cost-effective by preventing idle time, energy consumption and damage to the attachment machine. The lifting height is the distance from the ground surface of the agricultural land to the lowest point of a soil cultivating and/or material depositing device. The distance from the ground surface of the agricultural land to the lowest point of a soil cultivating and/or material depositing device is greater at the second lifting position than at the first lifting position. A greater distance between the soil cultivating and/or material depositing device and the ground surface is advantageous when carrying out maintenance work at the attachment machine in order to be able to better access the soil cultivating and/or material depositing devices. A greater distance between the soil cultivating and/or material depositing device and the ground surface is advantageous when reversing and/or cornering with the attachment machine at a high machine tilt in order to minimize the risk of the soil cultivating and/or material depositing devices colliding with the ground. When reversing, it can occur that the rear of the attachment machine may drop slightly for reasons of the chassis, for example, making a collision with the ground likely at a low lifting height. When cornering, it can occur that the side of the attachment machine on the outer side of the curve may drop due to the machine tilting while cornering, making a collision with the ground likely at a low lifting height. A high lifting position is therefore only necessary during maintenance work, when reversing, and when cornering with a high machine tilt to avoid collisions with the ground, for example, to prevent damage to tools and unwanted tearing up of the soil. A high lifting height is not necessary in all situations in which neither maintenance work nor reversing and/or cornering with a high machine tilt are performed. Moving soil cultivating and/or material depositing devices to a lower lifting height requires less time and uses less energy. It is therefore advantageous to set the high lifting height only when necessary and to set a lower lifting height in all other situations so that the time during which the soil cultivating and/or material depositing devices are lifted and therefore requires machine idle time is minimized.

A method according to the disclosure is furthermore preferred in which the at least one soil processing and/or material depositing device is lifted to the first lifting position by carrying out a first lifting motion of the at least one soil processing and/or material depositing device and the at least one soil processing and/or material depositing device is lifted to the second lifting position by carrying out a second lifting motion of the at least one soil processing and/or material depositing device, where the second lifting motion of the at least one soil processing and/or material depositing device goes beyond the first lifting position of the at least one soil processing and/or material depositing device when lifting the at least one soil processing and/or material depositing device to the second lifting position. The first lifting motion for lifting the at least one soil processing and/or material depositing device to the first lifting position follows a first lifting path. The second lifting motion for lifting the at least one soil processing and/or material depositing device to the second lifting position follows a second lifting path. The first lifting path and/or the second lifting path can have a linear and/or circular course, at least in sections. The first lifting motion and/or the second lifting motion, respectively, can be a linear motion and/or a rotary motion. A linear lifting motion is preferably carried out by way of a parallelogram linkage of the attachment machine. The lifting can be single-row parallelogram lifting. The first lifting path and the second lifting path can coincide up to the first lifting position.

In a further preferred embodiment of the method according to the disclosure, the first and/or the second lifting motion is a linear motion, in particular a vertical motion, and/or the first and/or the second lifting motion is a pivoting motion, where the pivoting motion is preferably carried out about a pivot axis extending transverse or parallel to the direction of travel. Due to the lifting motion along the lifting path, a lifting angle between the soil processing and/or material depositing device and the ground surface arises with a pivoting motion. The lifting angle can be in a range between 0 degrees and 90 degrees. The lifting angle at the first lifting position is preferably in a range between 5 degrees and 20 degrees, for example, 12 degrees, and at the second lifting position in a range between 20 degrees and 30 degrees, for example, 25 degrees.

In another preferred embodiment of the method according to the disclosure, the first lifting motion and the second lifting motion are carried out simultaneously at least in part when lifting the at least one soil processing and/or material depositing device. When lifting the at least one soil processing and/or material depositing device, for example, a pivoting motion and a substantially linear motion of the at least one soil processing and/or material depositing device can be carried out simultaneously, at least in part. Alternatively, the first lifting motion and the second lifting motion can be carried out consecutively when lifting the at least one soil processing and/or material depositing device.

In a further development of the method according to the disclosure, the material flow of a seed flow and/or of a fertilizer flow to the at least one material depositing device is controlled as a function of the current lifting position of the at least one material depositing device and/or an impending or current change in the lifting position of the at least one material depositing device. The material flow of a seed flow and/or of a fertilizer flow to the at least one material depositing device is preferably controlled by a switching device. The attachment machine can comprise a distribution device, for example, a distribution head. The switching device can control, for example, flaps in the distribution head for controlling the material flow of the seed and/or fertilizer flow. The flaps can be used to partially or completely close seed and/or fertilizer lines that lead from a storage container to the at least one material depositing device in order to regulate the volume flow of the seed and/or of the fertilizer and thereby the material flow. In addition, the attachment machine can comprise a nursing system, where the distribution device is then configured as a dispenser unit which distributes seed and/or fertilizer to receiver units of the individual material depositing devices. The switching device can also control a metering device, for example, a singling device and/or a portioning device, to control the material flow of the seed and/or fertilizer flow. The switching device can then temporarily stop the singling and/or metering of the seed and/or fertilizer. The seed flow and the fertilizer flow can preferably be controlled independently of one another. The seed flow and the fertilizer flow are preferably each switched on and/or off at different times. The length of the seed lines and the length of the fertilizer lines can differ from one another so that the conveying distances of the seed and the fertilizer are different. The flow speeds of the seed and the fertilizer along their respective conveying distances can also be different. The different conveying distances and the different flow speeds lead to a delay in delivery. A delivery delay is to mean the time difference between the times at which the fertilizer and the seed arrive at the at least one material depositing device. It is necessary for this time difference to be as small as possible and, ideally, be eliminated completely. In order to compensate for the different lengths of the conveying distances and the different flow speeds of the seed flow and the fertilizer flow and the resulting delivery delay, the fertilizer flow and the seed flow are switched on and/or off at different times so that the fertilizer flow and the seed flow arrive at the at least one material depositing device simultaneously. If there are several material depositing devices present, the material flow of the seed flow and/or of the fertilizer flow can preferably be controlled independently at each material depositing device. The material flow of the seed flow and/or of the fertilizer flow is preferably controlled as a function of the current direction of travel of the attachment machine and/or of an impending change in the direction of travel of the attachment machine. Controlling the material flow of the seed flow and/or of the fertilizer flow is preferably carried out as a function of the current lifting position of the at least one soil cultivating and/or material depositing device and/or on an impending change in the lifting position of the at least one soil cultivating and/or material depositing device.

A method according to the disclosure is also advantageous in which the lifting of at least one soil cultivating and/or material depositing device of the agricultural attachment machine is controlled by way of a control device as a function of the current direction of travel and/or of an impending change in the direction of travel of the agricultural attachment machine. The at least one soil cultivating and/or material depositing device of the agricultural attachment machine by way of the control device is preferably lifted in a self-acting manner. The at least one soil cultivating and/or material depositing device of the agricultural attachment machine by way of the control device can also be lifted in an automated manner following the confirmation of an operator request. The at least one soil cultivating and/or material depositing device of the agricultural attachment machine by way of the control device can furthermore be lifted manually by an operator, for example, by pressing a button or a key. The control device is preferably configured to control the switching device. Furthermore, the control device is preferably configured to control a lifting adjustment device which is configured to lift the at least one soil cultivating and/or material depositing device to the first or the second lifting position.

The object underlying the disclosure is furthermore satisfied by a control system of the kind mentioned at the outset, where the control system comprises a control device which is configured to cause temporary lifting of at least one soil cultivating and/or material depositing device of the agricultural attachment machine from a working position to a first predefined lifting position of at least two predefined lifting positions in at least a first category of maneuvering processes, and to cause temporary lifting of the at least one soil cultivating and/or material depositing device of the agricultural attachment machine from the working position to a second predefined lifting position of the at least two predefined lifting positions in at least a second category of maneuvering processes. The control device can be part of an operating terminal of the agricultural attachment machine.

In a preferred embodiment of the control system according to the disclosure, the control system comprises a switching device which is configured to change the material flow of a seed flow and/or of a fertilizer flow to the material depositing devices, where the control device is configured to control the switching device for changing the material flow of the seed flow and/or of the fertilizer flow to the material depositing devices as a function of the current lifting position of the material depositing devices and/or an impending or current change in the lifting position of the material depositing devices.

In another preferred embodiment of the control system according to the disclosure, the control system comprises a lifting adjustment device which is configured to lift the at least one soil cultivating and/or material depositing device to the first or the second lifting position, where the control device is configured to control the lifting adjustment device for lifting the at least one soil cultivating and/or material depositing device to the first or the second lifting position as a function of the current direction of travel and/or an impending change in the direction of travel of the agricultural cultivation machine. The lifting adjustment device can operate hydraulically, pneumatically, electrically, or mechanically. The lifting adjustment device can comprise one or more actuators, for example, servomotors and/or cylinders. The cylinders can be, for example, folding cylinders, in particular hydraulic folding cylinders.

In a further preferred embodiment of the control system according to the disclosure, the control system is configured to carry out the method according to one of the above embodiments. With regard to the advantages and modifications of the control system according to the disclosure, reference is therefore first made to the advantages and modifications of the method according to the disclosure.

The object underlying the disclosure is also satisfied by an agricultural attachment machine of the kind mentioned at the outset, where the attachment machine is configured to carry out the method according to one of the above embodiments and/or where the control system is configured according to one of the above embodiments. With regard to the advantages and modifications of the agricultural attachment machine according to the disclosure, reference is therefore first made to the advantages and modifications of the method according to the disclosure and the control system according to the disclosure.

### BRIEF DESCRIPTION OF THE DRAWINGS

Preferred embodiments shall be explained and described in more detail below with reference to the accompanying drawings, where:

FIG. 1 shows an agricultural attachment machine according to the disclosure with lifted soil cultivating and material depositing devices in a perspective view;

FIG. 2 shows the agricultural attachment machine from FIG. 1 with lifted soil cultivating and material depositing devices in a side view;

FIG. 3 shows an agricultural attachment machine travelling straight ahead during field cultivation on agricultural arable land with a tramline system in a top view;

FIG. 4 shows an agricultural attachment machine when cornering during field cultivation on agricultural arable land with a tramline system in a top view;

FIG. 5 shows an agricultural attachment machine when reversing during field cultivation on agricultural arable land with a tramline system in a top view;

FIG. 6 shows an agricultural attachment machine according to the disclosure with soil cultivating and material depositing devices in the working position in a side view;

FIG. 7 shows the agricultural attachment machine from FIG. 6 with soil cultivating and material depositing devices at a first lifting position in a side view;

FIG. 8 shows the agricultural attachment machine from FIG. 6 with soil cultivating and material depositing devices at a second lifting position in a side view;

FIG. 9 shows an agricultural attachment machine according to the disclosure with soil cultivating devices in the working position in a perspective view;

FIG. 10 shows the agricultural attachment machine from FIG. 9 with soil cultivating devices in the working position in a frontal view;

FIG. 11 shows the agricultural attachment machine from FIG. 9 with soil cultivating devices at a first lifting position in a frontal view; and

FIG. 12 shows the agricultural attachment machine from FIG. 9 with soil cultivating devices at a second lifting position in a frontal view.

### DETAILED DESCRIPTION

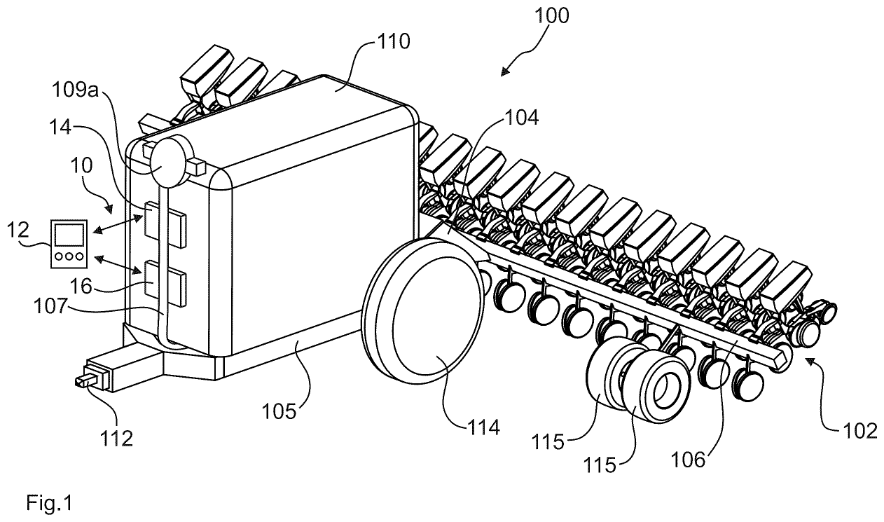

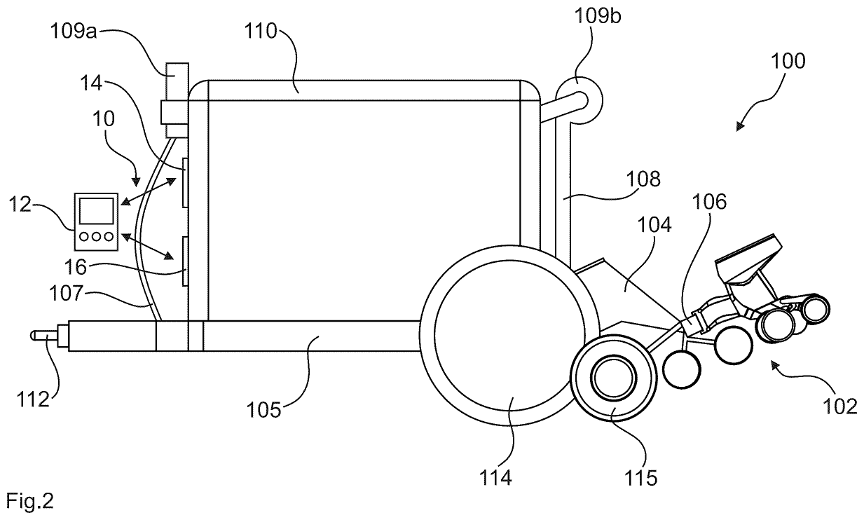

FIGS. 1 and 2 show an agricultural attachment machine 100 according to the disclosure which is configured as a seeder. Attachment machine 100 comprises a storage container 110 in which fertilizer and/or seed is stored and which is attached to a main frame 105. Seed and/or fertilizer is conveyed to soil cultivating and material depositing devices 102 by way of a seed and/or fertilizer line 107 using blower 109a. The seed and/or fertilizer is conveyed to soil cultivating and material depositing devices 102 by way of a nursing system. A dispenser unit acting as a distribution device distributes the seed and/or fertilizer to receiving units and thereafter to metering devices of the individual soil cultivating and material depositing devices 102. The metering devices can be singling devices for the seed or portioning devices for the fertilizer. A blower 109b can provide pressure via a blower line 108 for the singling devices. The soil of agricultural arable land N can be cultivated, and/or seed and/or fertilizer can be deposited on agricultural arable land N by way of soil cultivating and material depositing devices 102.

Attachment machine 100 also comprises wheels 114 for moving attachment machine 100 and support wheels 115 for supporting attachment machine 100, as well as a coupling device 112 by way of which attachment machine 100 can be attached to a drawing vehicle, for example, to a tractor. Soil cultivating and material depositing devices 102 are arranged on a carrier 106 of agricultural attachment machine 100 which in turn is attached to a rear frame 104. Rear frame 104 is attached to be pivotal on main frame 105 of attachment machine 100.

Agricultural attachment machine 100 also comprises a control system 10 according to the disclosure comprising a control device 12, a switching device 14, and a lifting adjustment device 16. Pivotable rear frame 104 together with carrier 106 and soil cultivating and material depositing devices 102 attached to carrier 106 can be pivoted by way of lifting adjustment device 12 so that the ground contact between soil cultivating and material depositing devices 102 and agricultural arable land N can be eliminated. The seed and/or fertilizer flow through the seed and/or fertilizer line 107 can be controlled by way of switching device 14, for example, by controlling flaps in a distributor head and/or the depositing of seed and/or fertilizer on arable land N can be controlled, for example, by controlling a metering device.

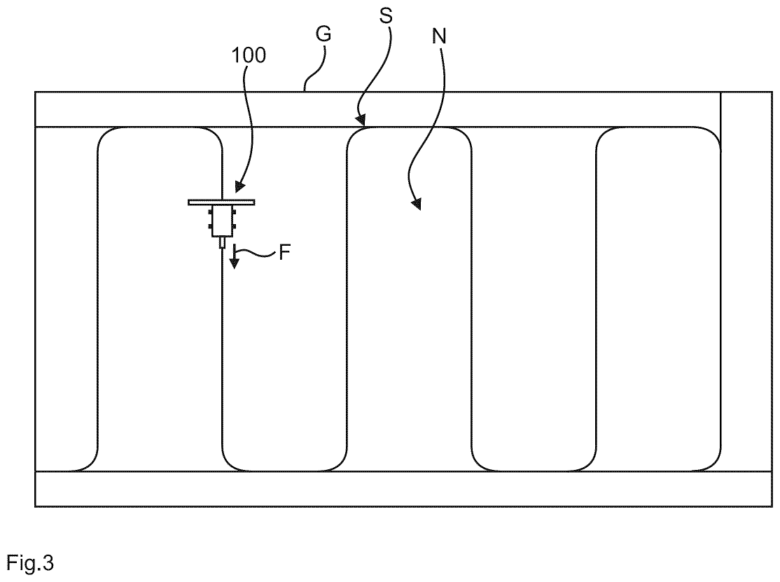

FIGS. 3 to 5 show agricultural arable land N with an agricultural attachment machine 100 during field cultivation in a top view. Attachment machine 100 follows a path of motion which is specified by a tramline system S which divides arable land N into partial regions. Agricultural arable land N is delimited from adjacent areas by a rectangular field boundary G.

In FIG. 3, agricultural attachment machine 100 is shown while travelling forward and straight ahead during a cultivation operation on agricultural arable land N. Agricultural attachment machine 100 travels forward and straight ahead according to its direction of travel F and follows a parallel travel lane specified by tramline system S. When travelling forward and straight ahead during field cultivation, soil processing and material depositing devices 102, 102a-102i of agricultural attachment machine 100 are disposed in a working position so that soil processing and material depositing devices 102, 102a-102i are in ground contact with agricultural arable land N.

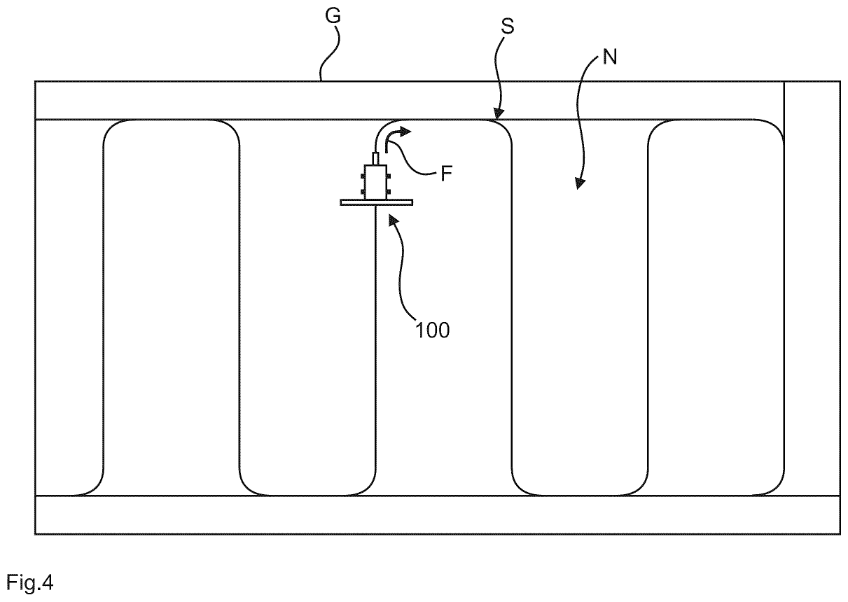

Agricultural attachment machine 100 is shown in FIG. 4 while cornering during a cultivation operation on agricultural arable land N. Agricultural attachment machine 100 travels forward according to its direction of travel F into a curve specified by tramline system S in order to turn around between two parallel travel lanes. When cornering during field cultivation, in particular during a turning maneuver, soil cultivating and material depositing devices 102, 102a-102i of agricultural attachment machine 100 are in one of at least two predefined lifting positions so that soil cultivating and material depositing devices 102, 102a-102i are not in ground contact with agricultural arable land N. When cornering without exceeding a limit value of the machine tilt during cornering, for example, when attachment machine 100 is traveling at a comparatively slow speed or with a large curve radius, soil cultivating and material depositing devices 102, 102a-102i are raised to a first, lower lifting position. When cornering and exceeding a limit value of the machine tilt during cornering, for example, when attachment machine 100 is traveling at a comparatively high speed or the curve radius is tight, soil cultivating and material depositing devices 102, 102a-102i are lifted to a second, higher lifting position.

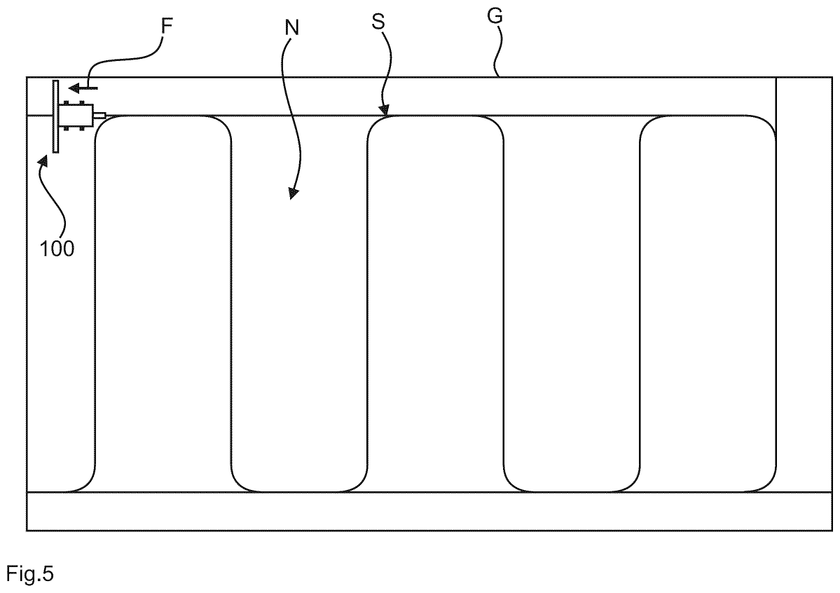

In FIG. 5, agricultural attachment machine 100 is shown when reversing and travelling straight ahead during a cultivation operation on agricultural arable land N. Agricultural attachment machine 100 reverses and travels straight ahead according to its direction of travel F and follows a travel lane in the headland specified by tramline system S. When reversing and traveling straight ahead during field cultivation, soil processing and material depositing devices 102, 102a-102i of agricultural attachment machine 100 are in a lifted position so that soil processing and material depositing devices 102, 102a-102i are not in ground contact with agricultural arable land N. When reversing, for example, to cultivate arable land N in a field corner near field boundary G in the headland, soil processing and material depositing devices 102, 102a-102i are lifted to a second, higher raised position.

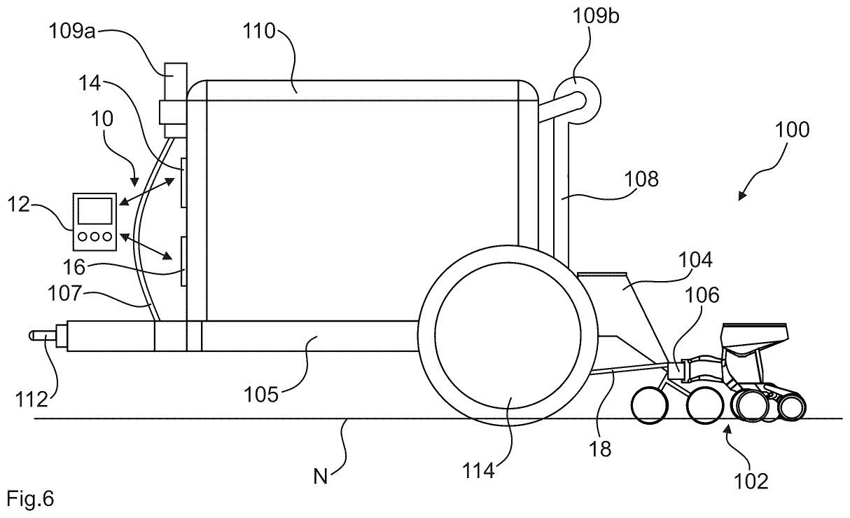

FIGS. 6 to 8 show an agricultural attachment machine 100 according to the disclosure configured as a seeder with a control system 10 according to the disclosure on agricultural arable land N having different positions of soil cultivating and material depositing devices 102.

FIG. 6 shows soil cultivating and material depositing devices 102 in a working position during field cultivation. In the working position, soil cultivating and material depositing devices 102 are in contact with the ground surface of agricultural arable land N and cultivate it. The working position is set, for example, when attachment machine 100, as shown in FIG. 3, moves forwards straight ahead on a parallel lane during field cultivation, for example, during a sowing process.

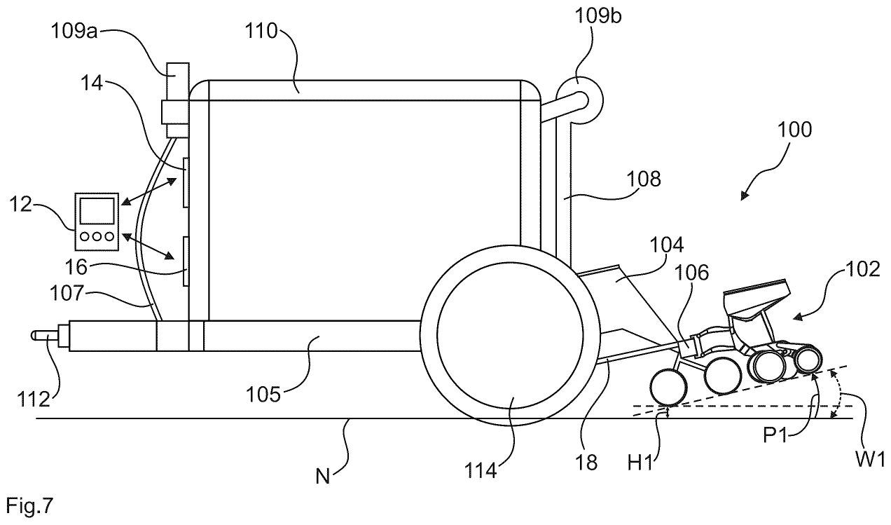

FIG. 7 shows soil cultivating and material depositing devices 102 at a first lifting position. At the first lifting position, the ground contact of soil cultivating and material depositing devices 102 with the ground surface of agricultural arable land N is eliminated and the cultivation of the soil is interrupted. To set the first lifting position, rear frame 104, which is attached to be rotatable on main frame 105, with soil cultivating and material depositing devices 102 attached to carrier 106 is pivoted along lifting path P1. For pivoting, control device 12 of control system 10 controls lifting adjustment device 16 of the control system. Lifting adjustment device 16 comprises an actuator 18 which is configured, for example, as a hydraulic cylinder by way of which soil cultivating and material depositing devices 102 are pivoted about a pivot axis running transverse to the direction of travel of attachment machine 100. At the first lifting position, a lifting height H1 which corresponds to the distance of the lowest point of soil cultivating and material depositing devices 102 from the ground surface of usable area N and a lifting angle W1 between soil cultivating and material depositing devices 102 and the arable land N arise. The first lifting position is set, for example, when attachment machine 100, as shown in FIG. 4, is in a turning process with cornering during the field cultivation, for example, during a sowing process. Due to the lower lifting height H1 at the first lifting position, a delay in field cultivation and can be prevented and energy can be saved as compared to a higher lifting position.

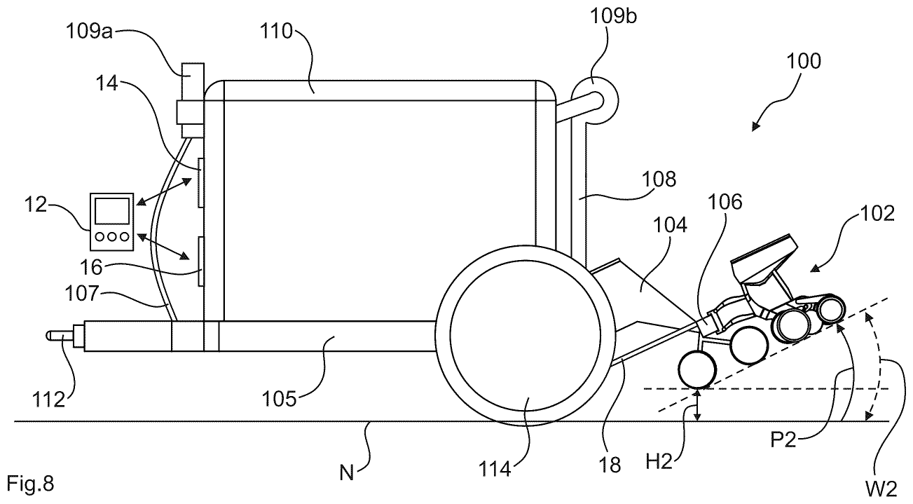

FIG. 8 shows soil cultivating and material depositing devices 102 at a second lifting position. At the second lifting position, ground contact of soil cultivating and material depositing devices 102 with the ground surface of agricultural arable land N is eliminated and the cultivation of the soil is interrupted. To set the second lifting position, rear frame 104, attached to be rotatable on main frame 105, with soil cultivating and material depositing devices 102 attached to carrier 106, is pivoted along lifting path P2 by way of actuator 18. At the second lifting position, a lifting height H2 and a lifting angle W2 between soil cultivating and material depositing devices 102 and arable land N arise. Lifting height H2 of the second lifting position is higher than lifting height H1 of the first lifting position Lifting angle W2 of the second lifting position is greater than lifting angle H1 of the first lifting position. Lifting path P2 is longer than lifting path P1. The second lifting position is set, for example, when attachment machine 100, as shown in FIG. 5, reverses during field cultivation, for example, in the headland for reaching the corners of the field. Due to higher lifting height H2 at the second lifting position, soil processing and material depositing devices 102 is prevented from colliding with the ground when reversing.

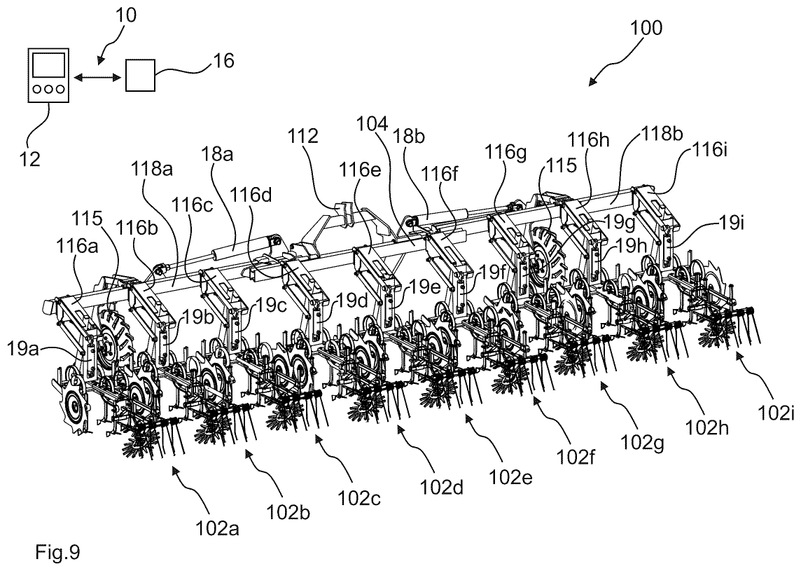

FIG. 9 shows a further embodiment of an agricultural attachment machine 100 according to the disclosure with a control system 10 according to the disclosure. Attachment machine 100 configured as a hoe comprises a rear frame 104 as well as booms 118a, 118b which are attached to be rotatable on rear frame 104 and which can be pivoted by way of actuators 18a, 18b about a pivot axis running parallel to the direction of travel of attachment machine 100. Furthermore, support wheels 115 are arranged on booms 118a, 118b and can support booms 118a, 118b on a ground surface. Attachment machine 100 can be attached to a drawing and/or carrier vehicle, for example, to a tractor, by way of a coupling device 112. Attachment machine 100 also comprises soil cultivating devices 102a-102i which are attached to steering assemblies 116a-116i. Soil cultivating devices 102a-102c are attached to boom 118a by way of steering assemblies 116a-116c. Soil cultivating devices 102e-102f are attached to rear frame 104 by way of steering assemblies 116e-116f. Soil cultivating devices 102g-102i are attached to boom 118b by way of steering assemblies 116g-116i. Steering assemblies 116a-116i are configured as a parallelogram linkage and can be adjusted by way of actuators 19a-19i such that soil cultivating devices 102a-102i are lifted. Control device 12 of control system 10 controls lifting adjustment device 16 for lifting soil cultivating devices 102a-102i by way of actuators 18a, 18b and/or 19a-19i.

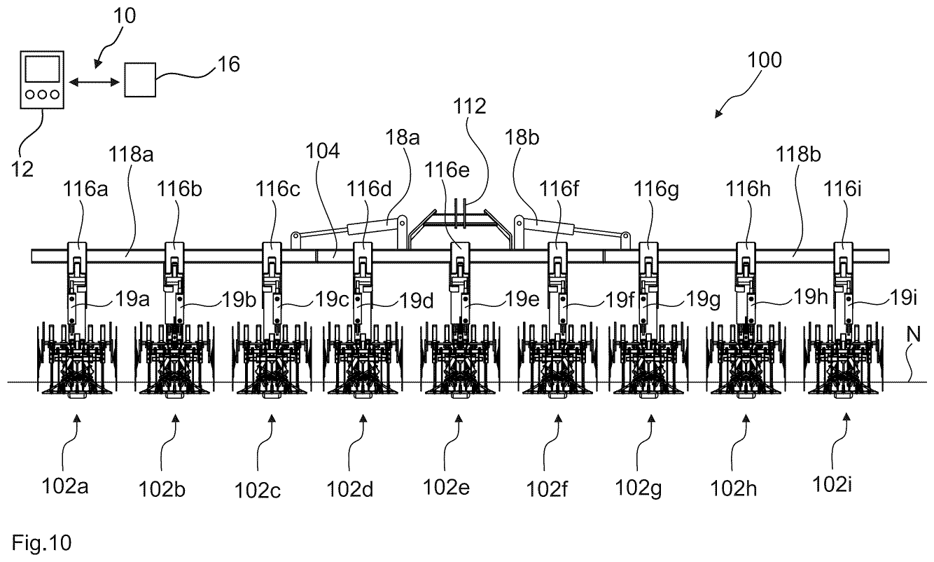

FIG. 10 shows agricultural attachment machine 100 from FIG. 9 with soil cultivating devices 102a-102i in the working position. In the working position, soil cultivating devices 102a-102i are in contact with the ground surface of agricultural arable land N and cultivate it. The working position is set, for example, when attachment machine 100, as shown in FIG. 3, moves forward straight ahead on a parallel travel lane during field cultivation.

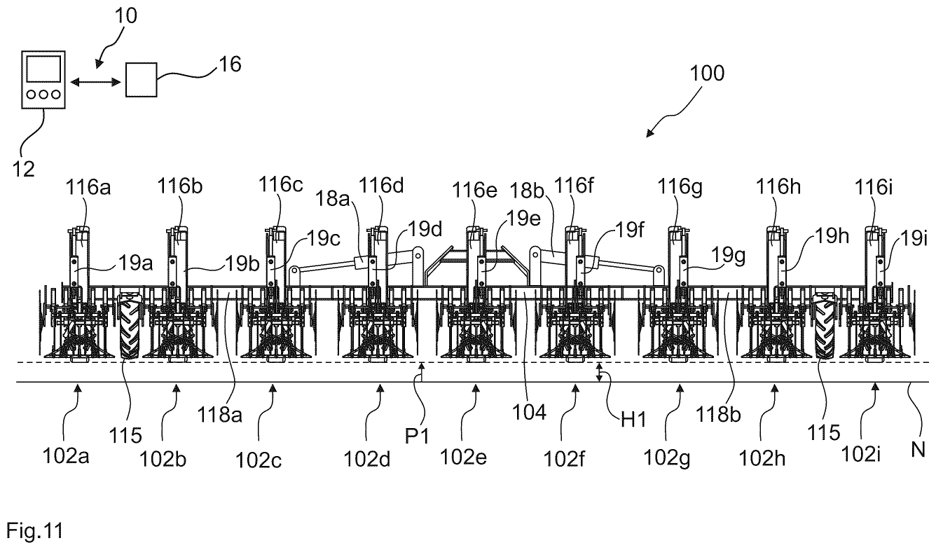

FIG. 11 shows soil cultivating devices 102a-102i of attachment machine 100 at a first lifting position. At the first lifting position, ground contact of soil cultivating devices 102 with the ground surface of agricultural arable land N is eliminated and the cultivation of the soil is interrupted. To set the first lifting position, soil cultivating devices 102a-102i are lifted by adjusting steering assemblies 116a-116i by way of actuators 19a-19i substantially linearly perpendicular to arable land N along lifting path P1 to lifting height H1. For lifting, control device 12 of control system 10 controls lifting adjustment device 16 of the control system. The first lifting position is set, for example, when attachment machine 100 is in a turning process with cornering during field cultivation, during which a limit value of the machine tilt is not exceeded. If attachment machine 100 is slightly tilted during cornering, the risk of soil cultivating devices 102a-102i colliding with the ground is comparatively low.

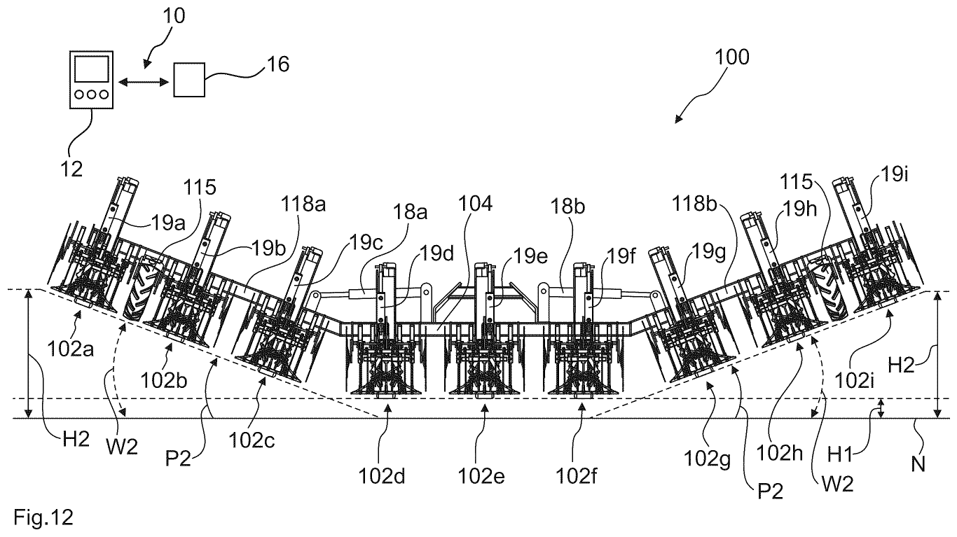

FIG. 12 shows soil cultivating devices 102a-102i at a second lifting position. At the second lifting position, ground contact of soil cultivating devices 102a-102i with the ground surface of agricultural arable land N is eliminated and the cultivation of the soil is interrupted. To set the second lifting position, soil cultivating devices 102a-102i are lifted to lifting height H1 by adjusting steering assemblies 116a-116i by way of actuators 19a-19i, substantially linearly perpendicular to arable land N along lifting path P1, and soil cultivating devices 102a-102c, 102g-102i are additionally lifted to lifting height H2 by way of actuators 18a, 18b by pivoting booms 118a, 188b along lifting path P2 so that lifting angle W2 arises. Lifting height H2 of the second lifting position is higher than lifting height H1 of the first lifting position Lifting path P2 is longer than lifting path P1. Lifting path P2 is composed of a linear motion up to lifting height H1 and a curved motion up to lifting height H2. The linear lifting by way of actuators 19a-19i to lifting height H1 and the pivoting by way of actuators 18a, 18b to lifting height H2 can be carried out simultaneously. The second lifting position is set, for example, when attachment machine 100 during field cultivation executes cornering in which a limit value of the machine tilt is reached or exceeded. If the machines are tilted severely, the risk of soil cultivating devices 102a-102i, in particular soil cultivating devices 102a-102c, 102g-102i arranged on booms 118a, 118b, colliding with the ground is high. Higher lifting height H2 at the second lifting position prevents soil cultivation devices 102a-102i from colliding with the ground when cornering with a severe machine tilt.

### LIST OF REFERENCE CHARACTERS

10 control system
12 control device
14 switching device
16 lifting adjustment device
18, 18a, 18b actuator
19a-19i actuator
100 agricultural attachment machine
102, 102a-102i soil cultivating and/or material depositing device
104 rear frame
105 main frame
106 carrier
107 seed and/or fertilizer line
108 blower line
109a, 109b blower
110 storage container
112 coupling device
114 wheels
115 support wheels
116a-116i steering assembly
118a, 118b boom
N agricultural arable land
F direction of travel
S tram line system
G field boundary
P1, P2 lifting path
H1, H2 lifting height
W1, W2 lifting angle

1. method for controlling the lift position on an agricultural attachment machine during a cultivation operation on agricultural arable land, comprising:
temporarily lifting at least one soil cultivating and/or material depositing device of said agricultural attachment machine from a working position to a first predefined lifting position of at least two predefined lifting positions in at least one first category of maneuvering processes, and
temporarily lifting said at least one soil cultivating and/or material depositing device of said agricultural attachment machine from said working position to a second predefined lifting position of said at least two predefined lifting positions in at least one second category of maneuvering processes.

2. The method according to claim 1, further comprising one or both of the following steps:
assigning at least one maneuvering process to said first or said second category of maneuvering processes prior to the maneuvering process being performed; or
assigning at least one maneuvering process to said first or said second category of maneuvering processes while the maneuvering process is being performed.

3. The method according to claim 2, wherein the assignment of the at least one maneuvering process to the first or the second category of maneuvering processes is carried out as a function of a current direction of travel and/or an impending change in the current direction of travel of said agricultural attachment machine.

4. The method according to claim 1,
said agricultural attachment machine does not reverse during the maneuvering processes of the first category, and
said agricultural attachment machine does reverse during the maneuvering processes of the second category.

5. The method according to, claim 1, wherein
during the maneuvering processes of the first category, no cornering takes place and/or said agricultural attachment machine performs cornering in which a limit value for the machine tilt is likely not to be exceeded; and
during the maneuvering processes of the second category, said agricultural attachment machine performs cornering in which a limit value for the machine tilt is likely to be reached or exceeded.

6. The method according to claim 3, further comprising:
determining the current direction of travel and/or an impending change in the current direction of travel of said agricultural attachment machine,
wherein the current direction of travel and/or an impending change in the current direction of travel of said agricultural attachment machine is determined based on
the current machine configuration or an impending change in the machine configuration of said attachment machine, and/or
the current operating status or an impending change in the operating status of said attachment machine

7. The method according to claim 6, wherein the current direction of travel and/or an impending change in the current direction of travel of said agricultural attachment machine is determined based on;
the current speed of motion and/or an impending change in the speed of motion of said attachment machine, and/or
the current geographical position of said attachment machine and/or an impending path of motion of said attachment machine.

8. The method according to claim 1, wherein said at least one soil cultivating and/or material depositing device is disposed at a first lifting height at the first predefined lifting position and at a second lifting height at the second predefined lifting position, where the second lifting height is higher than the first lifting height.

9. The method according to claim 3, where said at least one soil cultivating and/or material depositing device is lifted to the first predefined lifting position by carrying out a first lifting motion of said at least one soil cultivating and/or material depositing device and said at least one soil cultivating and/or material depositing device is lifted to the second predefined lifting position by carrying out a second lifting motion of said at least one soil processing and/or material depositing device, wherein the second lifting motion of said at least one soil
wherein the second lifting motion of said at least one soil cultivating and/or material depositing device goes beyond the first predefined lifting position of said at least one soil cultivating and/or material depositing device when said at least one soil cultivating and/or material depositing device is lifted to the second predefined lifting position.

10. Method according to claim 9, wherein
the first and/or the second lifting motion is a linear motion, and/or
the first and/or the second lifting motion is a pivoting motion, wherein the pivoting motion is carried out about a pivot axis extending transverse or parallel to the current direction of travel.

11. The method according to one of the claims 9, wherein the first lifting motion and the second lifting motion are carried out simultaneously at least in part when said at least one soil cultivating and/or material depositing device is lifted.

12. The method according to claim 1,
wherein the material flow of a seed flow and/or of a fertilizer flow to said at least one soil cultivating and/or material depositing device is controlled as a function of a current lifting position of said at least one soils cultivating and/or material depositing device and/or an impending or current change in the current lifting position of said at least one material depositing device.

13. The method according to claim 3, wherein lifting at least one soil cultivating and/or material depositing device of said agricultural attachment machine is controlled with a control device as a function of the current direction of travel and/or of an impending change in the current direction of travel of said agricultural attachment machine.

14. control system for controlling a lifting position of an agricultural attachment machine during a cultivation operation on agricultural arable land, characterized by a control device which is configured to cause temporary lifting of at least one soil cultivating and/or material depositing device of said agricultural attachment machine from a working position to a first predefined lifting position of at least two predefined lifting positions in at least a first category of maneuvering processes, and to cause temporary lifting of said at least one soil cultivating and/or material depositing device of said agricultural attachment machine from the working position to a second predefined lifting position of the at least two predefined lifting positions in at least a second category of maneuvering processes.

15. The control system according to claim 14, further comprising
a switching device which is configured to change a material flow of a seed flow and/or of a fertilizer flow to said soil cultivating and/or material depositing devices
wherein said control device is configured to control said switching device for changing the material flow of the seed flow and/or of the fertilizer flow to said soil cultivating and/or material depositing devices as a function of the lifting position of said soil cultivating and/or material depositing devices and/or an impending or current change in the lifting position of said soil cultivating and/or material depositing devices.

16. The control system according to claim 14,
a lifting adjustment device which is configured to lift said at least one soil cultivating and/or material depositing device to the first or the second lifting position,
wherein said control device is configured to control said lifting adjustment device for lifting said at least one soil cultivating and/or material depositing device to the first or the second lifting position as a function of a current direction of travel and/or an impending change in the current direction of travel of said agricultural cultivation machine.

17. The control system according to claim 14, wherein said control system is configured to carry out a method for controlling the lift position on an agricultural attachment machine during a cultivation operation on agricultural arable land comprising:
temporarily lifting at least one soil cultivating and/or material depositing device of said agricultural attachment machine from a working position to a first predefined lifting position of at least two predefined lifting positions in at least one first category of maneuvering processes, and
temporarily lifting said at least one soil cultivating and/or material depositing device of said agricultural attachment machine from said working position to a second predefined lifting position of said at least two predefined lifting positions in at least one second category of maneuvering processes.

18. (canceled)
